(19) United States
(12) Patent Application Publication
(10) Pub. No.: US 2006/0069170 A1
(43) Pub. Date: Mar. 30, 2006

(54) Decomposition of Polyester

(75) Inventors: Lloyd Ballard Mauldin, Cartersville, GA (US); Jerry Allen Cook, Cartersville, GA (US)

Correspondence Address: CHEMICAL PRODUCTS CORPORATION, P.O. BOX 2470, 102 OLD MILL ROAD S.E., CARTERSVILLE, GA, 30120-1692, US

(73) Assignee: Chemical Products Corporation, Cartersville, GA (US)

(21) Appl. No.: 10/708,479

(22) Filed: Sep. 27, 2004

(51) Int. Cl. C08J 11/04

(52) U.S. Cl. 521/48.5

(57) ABSTRACT

A process to decompose polyester by heating in the presence of a cyclic ester solvent is disclosed. Physically separated polyester-rich waste can be recycled by forming an admixture with a cyclic ester solvent, preferably propylene carbonate, and heating the admixture to a temperature above about 215 degrees Celsius. The polyester is decomposed into monomers and oligomers which are soluble in ethylene carbonate or propylene carbonate at ambient temperature. The polyester decomposition products are useful as components of an industrial solvent or as inputs to other chemical processes.

### BACKGROUND OF INVENTION

Poly(ethylene terephthalate) (PET) represents a significant portion of the post-consumer waste stream in the United States. Almost half of produced PET is recycled. Recycled PET is primarily material available in forms such as chips produced from soda bottles which have been physically separated from other waste material, washed, and dried. Much of the post-consumer PET waste cannot be physically separated to obtain sufficiently pure PET for recycle as PET polymer, but can only be concentrated into a polyester-rich waste component. It is important to find varied and higher value uses for this polyester-rich waste available for recycle. Accordingly, an economical process to allow reuse of these materials as industrial chemicals is desirable. Sufficiently pure PET scrap can be melted and reformed without depolymerization as described in U.S. Pat. Nos. 5,225,130; and 5,248,041.

At least three polyester tertiary recycling technologies are known. PET materials can be reacted with methanol to produce dimethyl terephthalate. This process, methanolysis, is the subject of U.S. Pat. No. 4,163,860 (Hoppert); U.S. Pat. No. 4,578,502 (Cudmore); U.S. Pat. No. 5,051,528 (Naujokas); U.S. Pat. No. 5,298,530 (Gamble); U.S. Pat. No. 5,391,263 (Hepner); and U.S. Pat. No. 5,414,022 Toot, Jr.). PET can also be reacted with ethylene glycol as described in column 1 of U.S. Pat. No. 4,078,143 (Malik); this process, glycolysis, apparently does not depolymerize the polyester completely to monomers, and is claimed to be less costly than methanolysis. Hydrolysis of PET under high temperatures and pressures yields terephthalic acid and ethylene glycol. Purification of the resulting terephthalic acid is costly, and this process does not appear to be economically attractive.

Depolymerizion of polyester is the subject of U.S. Pat. No. 5,414,106 (Smith); U.S. Pat. No. 5,414,107 (Smith); and U.S. Pat. No. 5,502,239 (Smith).

The existing recycling techniques suffer from relatively high process costs or product purity issues in the applications intended. The physical separation techniques employed to obtain a highly purified polyester material from some food packaging wastes have been successful, however these techniques are not universally applicable. Thus many polyester-rich wastes cannot be economically recycled using the existing polyester recycling techniques. Dissolution of polyester from polyester-rich waste streams, followed by decomposition into compounds which are soluble in ethylene carbonate or propylene carbonate at ambient temperature, offers a means to convert polyester waste directly into useful industrial solvents or inputs into other chemical processes.

The existing recycling techniques suffer from relatively high process costs or product purity issues in the applications intended. The physical separation techniques employed to obtain a highly purified polyester material from some food packaging wastes have been successful, however these techniques are not universally applicable. Thus many polyester-rich wastes cannot be economically recycled using the existing polyester recycling techniques. Dissolution of polyester from polyester-rich waste streams, followed by decomposition into compounds which are soluble in ethylene carbonate or propylene carbonate at ambient temperature, offers a means to convert polyester waste directly into useful industrial solvents or inputs into other chemical processes.

### SUMMARY OF INVENTION

This invention is directed to a process for decomposing the polyester component of post-consumer or post-industrial waste into compounds that are liquid at room temperature and are useful as solvents or as inputs for other chemical processes. This invention is particularly directed to a process for the decomposition of poly ethylene terephthalate).

A process for decomposition of polyester into compounds that are soluble in ethylene carbonate or propylene carbonate at ambient temperature is disclosed. The process of the present invention allows recycling of polyester directly into useful industrial chemicals which can be employed as components of industrial solvents for purposes such as paint and grease stripping.

### DETAILED DESCRIPTION

U.S. Pat. No. 4,118,187 (Sidebotham) and U.S. Pat. No. 4,137,393 (Sidebotham) employ solvents to selectively dissolve polyester from assortments of commingled fibers as a means of recovering unaltered polyester polymer of sufficient purity for reuse in polyester fiber production. One of the solvents named in these patents is the cyclic ester, propylene carbonate. U.S. Pat. No. 5,554,657 (Brownscombe) teaches the use of ethylene carbonate and propylene carbonate as solvents for polyester in the temperature range of 190 degrees to 200 degrees Celsius in an intricate process to recover polyester from a mixed polymer waste while maintaining the polyester polymer in polymer form.

Cyclic esters have been unexpectedly found to decompose dissolved polyester as the temperature of the solution is increased above about 215 degrees Celsius. This decomposition is evidenced by substantial reduction in the proportion of dissolved polyester that is recovered as precipitated polyester polymer upon cooling of the solution.

Poly(ethylene terephthalate) has been observed to dissolve in propylene carbonate only at a temperature between about 190 and 200 degrees Celsius. No appreciable dissolution of fibers is observed below a temperature of about 180 degrees Celsius. It has been unexpectedly discovered that polyester dissolved in cyclic esters decomposes when the solution is heated above a temperature of about 215 degrees Celsius. Upon cooling of the solution to ambient temperature, little or not precipitation of polyester polymer occurs. The polyester has been decomposed into monomeric and oligomeric units soluble in the cyclic ester solvent at ambient temperature. Thus, polyester extracted from polyester-rich waste streams by selective dissolution in a cyclic ester such as propylene carbonate or ethylene carbonate can be easily and immediately converted into a component of an industrial solvent by subjecting the polyester solution to increased temperature.

Polyester can be extracted from a mixed polymer waste by known techniques for dissolution in cyclic esters, solid-liquid separation may be necessary after dissolution of polyester but before decomposition of dissolved polyester depending upon the other constituents of the mixed polymer waste. Solid-liquid separation performed after decomposition of polyester should always be performed to yield a solvent solution containing minimal suspended solids.

The preferred solvent for dissolution of poly(ethylene terephthalate) is propylene carbonate. Propylene carbonate is known to be useful as a component of industrial solvents. U.S. Patent Application 20030119686 (Machac, Jr.) describes the environmental and employee health and safety benefits to be realized by utilization of industrial solvents containing propylene carbonate as opposed to more volatile and toxic solvents. Employing polyester decomposition products as a significant component of industrial solvents also containing cyclic esters such as ethylene carbonate, propylene carbonate, butylene carbonate, and mixtures thereof, will reduce the cost of these solvent compositions and allow them to compete more easily with some of the traditional industrial solvents.

Further details regarding the invention are set forth in the non-limiting example which follows. EXAMPLE Poly(ethylene terephthalate) yarn was cut into approximately 3 inch lengths, weighed, and place into an Erlenmeyer flask. Propylene carbonate was added to the flask such that 25 grams of poly(ethylene terephthalate) was admixed with 100 grams of propylene carbonate.

The Erlenmeyer flask was heated with gentle stirring on a hot plate. The poly (ethylene terephthalate) yarn was observed to be unaffected when the temperature of the admixture reached 180 degrees Celsius, but it had disappeared by the time the admixture had reached a temperature of 200 degrees Celsius. The admixture was further heated to a temperature of 220 degrees Celsius and held at this temperature of 15 minutes.

After the admixture was cooled to room temperature, it was filtered and the filtrate was weighted. Only 1.2 grams of solids were found in the admixture, thus approximately 95% of the polyester had been decomposed into compounds soluble in the propylene carbonate at room temperature.

The present invention may be embodied in other specific forms without departing from the spirit or essential attributes thereof, and accordingly, reference should be made to the appended claims, rather than to the foregoing specification, as indicating the scope of the invention.

1. A method for decomposing the polyester component of a commingled post-consumer or post-industrial waste into monomeric and oligomeric units constituting a portion of an ester solvent composition comprising: (a) admixing commingled waste with an initial ester solvent composition containing at least one cyclic ester; (b) heating the admixture to a temperature above about 215 degrees Celsius for a period of at least 3 minutes to form a second ester solvent composition; (c) cooling the second ester solvent composition to a temperature below about 70 degrees Celsius; and (d) separating the second ester solvent composition from solid impurities by sedimentation, flocculation, filtration, centrifugation, or combinations thereof.

2. The method of claim 1 wherein in step (a) the initial ester solvent composition comprises about 98% to about 30% by weight of the admixture.

3. The method of claim 1 wherein in step (a) the polyester materials physically separated from post-consumer or post-industrial waste are poly(ethylene terephthalate).

4. The method of claim 1 wherein in step (b) the admixture is heated to a temperature above about 230 degrees Celsius.

5. The method of claim 1 wherein in step (b) the admixture is held at a temperature above about 215 degrees Celsius for a period of at least 15 minutes.

6. The method of claim 1 wherein in step (a) the initial ester solvent composition is constituted principally of ethylene carbonate, propylene carbonate, butylene carbonate, or combinations thereof.

7. The method of claim 1 wherein in step (a) the initial ester solvent composition is constituted principally of propylene carbonate.

8. A method for decomposing poly(ethylene terephthalate) face fibers from post-consumer carpet into components of a liquid ester solvent composition comprising: (a) admixing the poly(ethylene terephthalate) face fibers with an initial ester solvent composition containing principally ethylene carbonate, propylene carbonate, butylene carbonate, or mixtures thereof; (b) heating the admixture to a temperature above about 220 degrees Celsius for a period of at least about 5 minutes to form a second ester solvent composition; (c) separating the second ester solvent composition from solid polyester and impurities by electrophoresis, sedimentation, flocculation, filtration, centrifugation, or combinations thereof; (d) cooling the second ester solvent composition to a temperature below about 30 degrees Celsius; and (e) separating the cooled second ester solvent composition from precipitated solids by electrophoresis, sedimentation, flocculation, filtration, centrifugation, or combinations thereof.

9. The method of claim 8 wherein in step (a) the solvent is propylene carbonate, ethylene carbonate, or mixtures thereof.

10. The method of claim 8 wherein in step (b) the admixture is heated to a temperature above about 230 degrees Celsius.

11. The method of claim 8 wherein in step (a) the poly(ethylene terephthalate) face fibers constitute between 2% and 50% by weight of the admixture.

12. A method for decomposing polyester into compounds having an appreciable solubility in cyclic esters at about 30 degrees Celsius and constituting a component of a liquid ester solvent composition comprising: (a) admixing polyester with ethylene carbonate, propylene carbonate, butylene carbonate, or mixtures thereof; (b) heating the admixture to a temperature above about 220 degrees Celsius for a period of at least about 5 minutes to form an ester solvent composition; (c) separating the ester solvent composition from solid polyester and impurities by sedimentation, flocculation, filtration, centrifugation, or combinations thereof; (d) cooling the ester solvent composition to a temperature below about 50 degrees Celsius; and (e) separating the cooled ester solvent composition from precipitated solids by sedimentation, flocculation, filtration, centrifugation, or combinations thereof.

13. The method of claim 12 wherein in step (a) polyester is admixed with propylene carbonate.

14. The method of claim 12 wherein in step (b) the admixture is held at a temperature above about 220 degrees Celsius for a period of more than about 15 minutes.

15. The method of claim 12 wherein in step (d) the ester solvent composition is cooled to ambient temperature.

16. The method of claim 12 wherein in step (b) the admixture is heated to a temperature above about 230 degrees Celsius.

17. Chemical compositions employed as solvents containing at least (1) decomposition products of poly(ethylene terephthalate) polyester and (2) one or more cyclic esters.

18. Chemical compositions employed as solvents containing as one component compounds resulting from the thermal degredation of poly(ethylene terephthalate) dissolved in ethylene carbonate, propylene carbonate, butylene carbonate, or mixtures thereof.
